(19) United States
(12) Patent Application Publication
(10) Pub. No.: US 2024/0419989 A1
(43) Pub. Date: Dec. 19, 2024

(54) DISTRIBUTION-BASED RISK MANAGEMENT IN CLASSIFICATION MODELS

(71) Applicant: NORTHROP GRUMMAN SYSTEMS CORPORATION, FALLS CHURCH, VA (US)

(72) Inventors: ABHISHEK PAUL, Melbourne, FL (US); JOSHUA B. MUTUGI, Oviedo, FL (US); NEEL A. SHAH, Placentia, CA (US)

(21) Appl. No.: 18/393,263

(22) Filed: Dec. 21, 2023

Related U.S. Application Data
(60) Provisional application No. 63/521,134, filed on Jun. 15, 2023.

(51) Int. Cl. G06N 5/04; G06N 20/00

(52) U.S. Cl. CPC G06N 5/04; G06N 20/00

(57) ABSTRACT

Systems and methods are provided for risk management in an expert system. A distribution of feature values within a training dataset for the expert system and each of a plurality of baseline datasets are determined, and Kullback-Leibler divergences between the baseline dataset and the training dataset to provide set of Kullback-Leibler divergence values. Measures of central tendency and statistical dispersion of the set of Kullback-Leibler divergence values are determined, and a threshold Kullback-Leibler divergence value is determined from these values and a desired confidence interval for new datasets. A Kullback-Leibler divergence value between the feature values of novel dataset and the training dataset is determined and it is determined that the second dataset represents an unacceptable divergence if this Kullback-Leibler divergence value exceeds the threshold value.

### RELATED APPLICATIONS

This application claims priority from U.S. Provisional Patent Application No. 63/521,134, filed 15 Jun. 2023, and entitled “DISTRIBUTION-BASED RISK MANAGEMENT IN NATURAL LANGUAGE MODELS.” The entirety of this application is hereby incorporated by reference.

### TECHNICAL FIELD

This invention relates to machine learning systems, and more particularly, to distribution-based risk management in classification models.

### BACKGROUND

Over the past several years, there have been many advancements with machine learning (ML) and identifying the impact this new technology can have across industries. Through this process, supervised ML and natural language processing (NLP) have proven to be effective for automating tasks in research environments with problems such as multi-class text classification. A major underlying assumption with supervised machine learning models is that the environment in which they operate is relatively stable, that is, the set of examples provided to the model for training and validation are similar to the set of examples classified by the system. Supervised learning models work well in environments that are similar to the environment in which the model was trained and tested, but if the environment changes while the machine learning model is in production, the model may provide erroneous predictions.

### SUMMARY OF THE INVENTION

In accordance with an aspect of the present invention, a method comprises determining a distribution of feature values within a first dataset of samples used to train an expert system and determining, for each of a plurality of baseline datasets received at the expert system, a Kullback-Leibler divergence between the feature values in the baseline dataset and the feature values in the first dataset to provide set of Kullback-Leibler divergence values. A measure of central tendency and a measure of statistical dispersion of the set of Kullback-Leibler divergence values are determined, and a threshold Kullback-Leibler divergence value, representing an unacceptable divergence of the distribution of feature values within a new dataset from the distribution of feature values within the first dataset of samples, is determined from a desired confidence interval for new datasets, the measure of central tendency of the dataset of Kullback-Leibler divergence values, and the measure of statistical dispersion of the dataset of Kullback-Leibler divergence values. For a second dataset received at the expert system, a Kullback-Leibler divergence value between the feature values of the second dataset and the feature values of the first dataset is determined and it is determined that the second dataset represents an unacceptable divergence from the distribution of features within the first dataset of samples if the Kullback-Leibler divergence value between the feature values of the second dataset and the feature values of the first dataset exceeds the threshold value.

In according to another aspect of the present invention, a system includes a processor and a non-transitory computer readable medium storing computer readable instructions executable by the processor to provide an expert system and a risk management component. The risk management component includes a training set characterization component that determines a distribution of feature values within a first dataset of samples used to train the expert system and a baseline characterization component. The baseline characterization component determines, for each of a plurality of baseline datasets received at the expert system, a Kullback-Leibler divergence between the feature values in the baseline dataset and the feature values in the first dataset to provide a set of Kullback-Leibler divergence values, determines a measure of central tendency and a measure of statistical dispersion of the set of Kullback-Leibler divergence values, and determines a threshold Kullback-Leibler divergence value, representing an unacceptable divergence of the distribution of feature values within a new dataset from the distribution of feature values within the first dataset of samples, from a desired confidence interval for new datasets, the measure of central tendency of the dataset of Kullback-Leibler divergence values, and the measure of statistical dispersion of the dataset of Kullback-Leibler divergence values. A monitoring system determines, for a second dataset received at the expert system, a Kullback-Leibler divergence value between the feature values of the second dataset and the feature values of the first dataset and determines that the second dataset represents an unacceptable divergence from the distribution of features within the first dataset of samples if the Kullback-Leibler divergence value between the feature values of the second dataset and the feature values of the first dataset exceed the threshold value.

In accordance with yet another aspect of the present invention, a method is provided for risk management in a document classification system. A distribution of feature values within a first dataset of samples used to train an expert system is determined. Each of the samples in the first dataset of samples represents a document. For each of a plurality of baseline datasets received at the expert system, a Kullback-Leibler divergence between the feature values in the baseline dataset and the feature values in the baseline dataset is determined to provide set of Kullback-Leibler divergence values, and a mean and standard deviation of the set of Kullback-Leibler divergence values is determined. A threshold Kullback-Leibler divergence value, representing an unacceptable divergence of the distribution of feature values within a new dataset from the distribution of feature values within the first dataset of samples, is determined from a desired confidence interval for new datasets, the mean and standard deviation of the dataset of Kullback-Leibler divergence values, and Chebyshev's inequality. For a second dataset received at the expert system, a Kullback-Leibler divergence value between the feature values of the second dataset and the feature values of the first dataset is determined, and it is determined that the second dataset represents an unacceptable divergence from the distribution of features within the first dataset of samples if the Kullback-Leibler divergence value between the feature values of the second dataset and the feature values of the first dataset exceed the threshold value.

### BRIEF DESCRIPTION OF THE DRAWINGS

FIG. 1 illustrates a classification system that utilizes distribution-based risk management;

FIG. 2 illustrates an example of one implementation of a risk management system that can be utilized in the system of FIG. 1;

FIG. 3 illustrates a system for classifying documents that utilizes distribution- based risk management;

FIG. 4 illustrates a method for evaluating an incoming dataset for compatibility with a dataset used to train an expert system; and

FIG. 5 is a schematic block diagram illustrating an exemplary system of hardware components for implementing the systems and methods described herein.

### DETAILED DESCRIPTION

As used herein, a “measure of central tendency” of a dataset is a descriptive statistic representing a central or representative value for the dataset. Measures of central tendency can include, but are not limited to, the mean (e.g., the arithmetic mean, the geometric mean, the harmonic mean, or another mean), the median, the mid-range, the mid-hinge, the interquartile mean, and the trimean of a dataset. It will be appreciated that means can be weighted, truncated, or windsorized.

As used herein, a “measure of statistical dispersion” for a dataset is a descriptive statistic representing measure of the extent to which the data varies around a central or representative value. Measures of statistical dispersion can include, but are not limited to, the variance, the standard deviation, the range, the interquartile range, the median absolute deviation, the mean absolute deviation, the average absolute deviation, the entropy, the Gini coefficient, the relative mean difference, and the coefficient of variation of a dataset.

A used herein, the “Kullback-Leibler divergence”, or “KL divergence”, D_{KL}, between of a first discrete probability distribution, P, from a second discrete probability distribution, Q, each defined on a sample space, X, is defined as:

D_{KL}(P || Q)=Σ_{x∈X}P(x)log( P(x)/Q(x)) Eq. 1

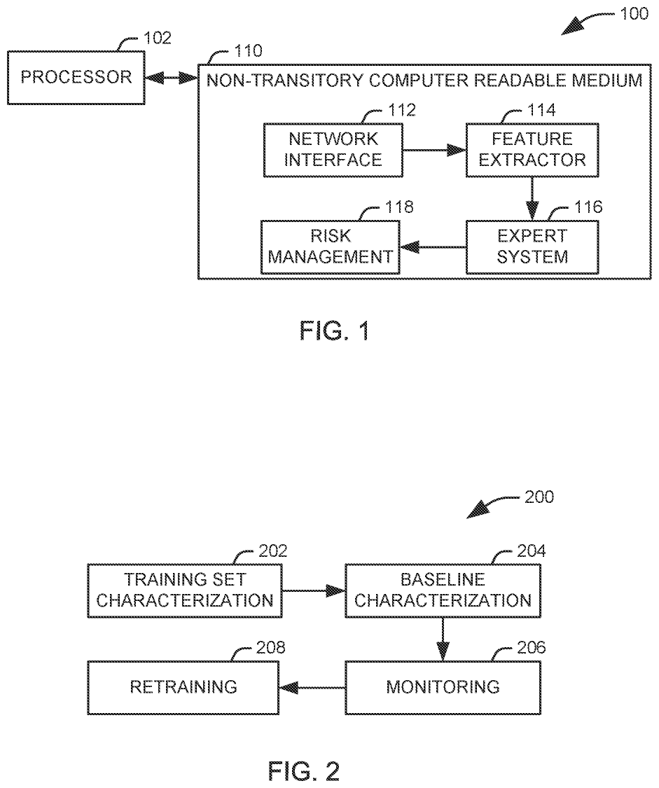

The systems and methods provided herein provide a probabilistic approach to monitoring a supervised machine learning (ML) model, for example, an ML model applying natural language processing (NLP). The effort produces a new probabilistic method that measures the environment in production to provide a signal that alerts of a potential environmental change for the model. FIG. 1 illustrates a classification system 100 that utilizes distribution-based risk management. The system 100 includes a processor 102 and a non-transitory computer readable medium 110 storing computer readable instructions, executed by the processor 102. The executable instructions stored on the non-transitory computer readable medium 110 include a network interface 112 via which the system 100 communicates with other systems (not shown) via a network connection, for example, an Internet connection and/or a connection to an internal network. In the illustrated example, the other systems can include a database system that stores novel samples that are retrieved for classification. It will be appreciated that the system 100 can be implemented as a virtual or cloud server, in which case the processor 102 and the non-transitory computer readable medium 110 may be shared by other applications.

A feature extractor 114 receives a novel sample, that is, a sample that was not presented in a training set for the model, and extracts a plurality of features for use at an expert system 116. A feature can be any numerical value representing the sample that is relevant to the classification process, and it will be appreciated that the features can vary with the nature and format of the training sample (e.g., image, audio file, text, etc.), the subject of the training sample, and the classes associated with the classification process. In the illustrated system, the expert system 116 uses the extracted features to classify the novel sample into one or more of a plurality of categories, or classes. The expert system 116 can utilize one or more pattern recognition algorithms, implemented, for example, as classification and regression models, each of which analyze the extracted features or a subset of the extracted features to classify the reports into one of the categories. The selected category can be provided to a user at an associated display (not shown) or stored on the non-transitory computer readable medium 110, for example, in a record associated with the sample.

The expert system 116, and any constituent pattern recognition algorithms, can be trained on a set of training data, with each sample in the set of training data comprising values for each of a set of features and an associated output class. In general, training data can be generated by applying the feature extractor 114 to samples having a known output class. An initial distribution of the values for each of the features and the output classes of the samples can be obtained and stored to represent an initial distribution of the training set.

In one example, each category is represented by an individual machine learning model in a one-vs-all arrangement. In this example, each of a plurality of machine learning models are trained as a binary classifier that distinguishes between a code category associated with the machine learning model and all other classes. In this example, the output of the machine learning model is a categorical or continuous parameter that reflects a likelihood that the sample is properly categorized with the code represented by the machine learning model. An arbitration element can be utilized to provide a coherent result from the plurality of machine learning models, for example, as the class having a highest continuous output or the highest confidence in a categorical output. In one example, the arbitration element can itself be implemented as a classification model that receives the outputs of the plurality of models as features and generates one or more categories for the samples.

The machine learning models can be trained on training data representing the various classes of interest. In one implementation, the machine learning model can use different model architectures, different sets of associated features, and different (or no) preprocessing techniques. The training process of a given model will vary with its implementation, but training generally involves a statistical aggregation of training data into one or more parameters associated with the output classes. Any of a variety of techniques can be utilized for the models, including support vector machines (SVMs), regression models, self-organized maps, fuzzy logic systems, data fusion processes, boosting and bagging methods, rule-based systems, or artificial neural networks (ANNs).

For example, an SVM classifier can utilize a plurality of functions, referred to as hyperplanes, to conceptually divide boundaries in the N-dimensional feature space, where each of the N dimensions represents one associated feature of the feature vector. The boundaries define a range of feature values associated with each class. Accordingly, an output class and an associated confidence value can be determined for a given input feature vector according to its position in feature space relative to the boundaries. An SVM classifier utilizes a user-specified kernel function to organize training data within a defined feature space. In the most basic implementation, the kernel function can be a radial basis function, although the systems and methods described herein can utilize any of a number of linear or non-linear kernel functions.

An ANN classifier comprises a plurality of nodes having a plurality of interconnections. The values from the feature vector are provided to a plurality of input nodes. The input nodes each provide these input values to layers of one or more intermediate nodes. A given intermediate node receives one or more output values from previous nodes. The received values are weighted according to a series of weights established during the training of the classifier. An intermediate node translates its received values into a single output according to a transfer function at the node. For example, the intermediate node can sum the received values and subject the sum to a binary step function. A final layer of nodes provides the confidence values for the output classes of the ANN, with each node having an associated value representing a confidence for one of the associated output classes of the classifier.

A regression model applies a set of weights to various functions of the extracted features, most commonly linear functions, to provide a continuous result. In general, regression features can be categorical, represented, for example, as zero or one, or continuous. In a logistic regression, the output of the model represents the log odds that the source of the extracted features is a member of a given class. In a binary classification task, these log odds can be used directly as a confidence value for class membership or converted via the logistic function to a probability of class membership given the extracted features.

A rule-based classifier applies a set of logical rules to the extracted features to select an output class. Generally, the rules are applied in order, with the logical result at each step influencing the analysis at later steps. The specific rules and their sequence can be determined from any or all of training data, analogical reasoning from previous cases, or existing domain knowledge. One example of a rule-based classifier is a decision tree algorithm, in which the values of features in a feature set are compared to corresponding threshold in a hierarchical tree structure to select a class for the feature vector. A random forest classifier is a modification of the decision tree algorithm using a bootstrap aggregating, or “bagging” approach. In this approach, multiple decision trees are trained on random samples of the training set, and an average (e.g., mean, median, or mode) result across the plurality of decision trees is returned. For a classification task, the result from each tree would be categorical, and thus a modal outcome can be used.

A risk management component 118 monitors the properties of samples classified by the expert system 116 to ensure that the operating environment of the expert system 116 has not significantly changed. To this end, the risk management component continuously records a distribution of features from incoming samples for classification at the expert system 116 and compares the subset of features to a baseline feature distribution to determine if the current distribution of features in the incoming samples is consistent with the baseline feature distribution or represents a change in the environment from which features are drawn. Such a change in the environment can occur naturally, as the character of samples to be classified changes, but can also result from malicious action to alter the behavior of the feature extractor 114 or the datasets received at the feature extractor.

The risk management component 118 first builds up a baseline dataset sample distribution based on comparisons of incoming datasets to the baseline feature distribution representing the data used to train and test the expert system 116. It will be appreciated that the size of incoming datasets, including both the baseline dataset samples and samples to be tested, can be standardized to include at least a certain number of samples to ensure that the feature values providing a meaningful distribution. A Kullback-Leibler divergence for each dataset can then be computed to provide a set of Kullback-Leibler divergence values for the baseline dataset samples. Descriptive statistics, including a measure of central tendency and a measure of statistical dispersion, can then be computed for this set of baseline dataset samples to represent the distribution of incoming datasets. It will be appreciated that this can be performed once, resulting in a static distribution, or windowed to allow for gradual changes in the environment to be reflected in the distribution. In one implementation, the standard deviation and mean of the set of Kullback-Leibler divergence values are used to represent the distribution.

The inventors have determined that the distribution of incoming datasets does not necessarily satisfy the presumption of normality that underlies many common techniques in statistical analysis. Accordingly, to determine a threshold Kullback-Leibler divergence value for rejecting a dataset, Chebyshev's inequality can be used. For a wide class of probability distributions, Chebyshev's inequality states that no more than 1/k² of the distribution's values can be k or more standard deviations away from the mean. Accordingly, for any desired confidence interval, a threshold number of standard deviations, and thus a threshold Kullback-Leibler divergence value, can be determined that represents a sample dataset falling outside of the confidence interval. Once this threshold is calculated from the baseline dataset samples, Kullback-Leibler divergence s for newly received datasets can be determined and compared to the threshold to determine if the newly received dataset diverges unacceptably from training dataset. Accordingly, when an incoming dataset provides a Kullback-Leibler divergence value that exceeds the determined threshold, an alarm can be provided to a user, and optionally, classification of further samples can be halted until further input from the user is received. Further, the expert system 116 can be retrained using either the original training set, a new training set representing a changed environment, taking the expert system offline, or restoring the expert system from a stored backup in response to the determination.

FIG. 2 illustrates an example of one implementation of a risk management component 200 that can be utilized in the system of FIG. 1. It will be appreciated that the illustrated risk management component 200 can be implemented as software instructions stored on a computer-readable medium and executed by an associated processor (not shown). The risk management component 200 includes a training set characterization component 202 that determines a distribution of feature values within a training dataset of samples used to train the expert system. Specifically, the training set characterization component 202 generates a discrete probability distribution for the feature values in the training dataset, and, to this end, any continuous features or discrete features with a large number of possible values can be binned into selected ranges to allow for the discrete probability distribution to be generated.

A baseline characterization component 204 determines a threshold Kullback-Leibler divergence value, representing an unacceptable divergence of a distribution of feature values within a new dataset from the distribution of feature values within the training dataset of samples. To this end, the baseline characterization component 204 receives evaluates a plurality of baseline datasets received at the expert system to generate a discrete probability distribution for each of the baseline datasets. It will be appreciated that the baseline datasets can simply be samples received in the ordinary operation of the expert system, with groups of similar size accumulated to serve as the various baseline dataset. For each of the plurality of baseline datasets, the baseline characterization component 204 can calculate a Kullback-Leibler divergence between the feature values in the baseline dataset and the feature values in the training dataset to provide a set of Kullback-Leibler divergence values. The baseline characterization component 204 then determines a measure of central tendency and a measure of statistical dispersion of the set of Kullback-Leibler divergence values, for example, a mean and standard deviation. From these values and a desired confidence interval for new datasets, the baseline characterization component 204 determines the threshold Kullback-Leibler divergence value. In one example, the threshold value is determined according to Chebyshev's inequality.

A monitoring system 206 determines, for a novel dataset received at the expert system, a Kullback-Leibler divergence value between the feature values of the novel dataset and the feature values of the training dataset and determines if the novel dataset represents an unacceptable divergence from the distribution of features within the training dataset of samples. Specifically, the divergence is considered to be unacceptable if the Kullback-Leibler divergence value between the feature values of the second dataset and the feature values of the first dataset exceed the threshold value. A retraining component 208 retrains the expert system in response to a determination at the monitoring system that the second dataset represents an unacceptable divergence of from the distribution of features within the first dataset of samples. For example, the retraining component 208 can restore the expert system from a backup or retrain it with the original training set to respond to malicious changes to the expert system and its surrounding infrastructure or retrain it with a new training set based on the novel data to respond to a change in the environment. In one example, the retraining component 208 operates at the direction of a user or group of users. For example, an operations team can be alerted by the monitoring system 206 to review the divergence of the received datasets from the training dataset, determining the cause and severity of the issue causing the divergence, and instruct the retraining component 208 to take the appropriate action. In this instance, the retraining process can be monitored by the operations team to ensure that the expert system is retrained appropriately. In another example, analysis of the issue causing the divergence is performed by the retraining component 208 before taking action to remediate the divergence.

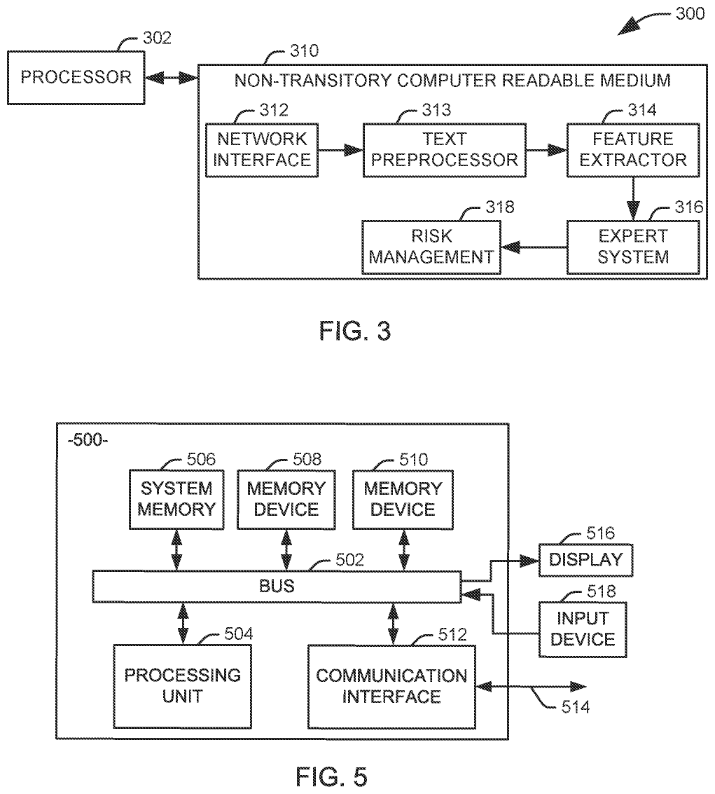

FIG. 3 illustrates a system 300 for classifying documents that utilizes distribution-based risk management. It will be appreciated that the documents classified by the system 300 can include unstructured documents or semi-structured documents having one or more free text fields. The system 300 can categorize each document into a category representing a subject of the document. The system 300 includes a processor 302 and a non-transitory computer readable medium 310 storing computer readable instructions, executed by the processor 302. The executable instructions stored on the non-transitory computer readable medium 310 include a network interface 312 via which the system 300 communicates with other systems (not shown) via a network connection, for example, an Internet connection and/or a connection to an internal network. In the illustrated example, the other systems can include a database system that stores the documents retrieved for classification. It will be appreciated that the system 300 can be implemented as a virtual or cloud server, in which case the processor 302 and the non-transitory computer readable medium 310 may be shared by other applications.

In the illustrated example, documents can be extracted from the database (not shown) or a user terminal (not shown) via the network interface 312 and provided to a text preprocessor 313. The text preprocessor 313 can apply various techniques to prepare text for analysis by an automated system, including, but not limited to, combining multiple free text fields in a semi-structured document, removing case from the individual letters, removing white space and punctuation between words, separating the text into tokens, such as words or phrases, removing stop words, that is, common words with little value for distinguishing among categories, such as articles, common verbs (e.g., various conjugations of “to be” or “to do”, and common prepositions (e.g., “for”, “to”), and stemming the words to a base of the word lacking common prefixes and suffixes.

A feature extractor 314 receives a document from the text preprocessor 313 and extracts a plurality of features from the document for use at an expert system 316. To this end, the feature extractor 314 can compute the frequencies of various terms within the extracted text. In one implementation, a straight count of each token can be used. In another example, the tokens are normalized according to the total number of relevant tokens found in a given document, referred to herein as “normalized count occurrence.” In a third implementation, the bag-of-words features can be weighted using the token frequency according to term frequency—inverse document frequency (tfidf), such that terms that occur relatively infrequently across reports are accorded more weight per occurrence than more common terms. In practice, a given implementation of the system 300 can use multiple of these approaches as options for each classification model.

The feature extractor 314 can then utilize the computed frequencies as part of one or more natural language processing algorithms for extracting data from unstructured text. It will be appreciated that, in some implementations, the category code assigned by the individual completing the document can be given some degree of weight in the classification task. In other implementations, the category is assigned without regard to the original classification based on the content of the free text. In one example, a bag-of-words approach is utilized. In the bag-of-words approach, each report is represented as a feature vector generated according to the frequency of terms within the report, either via straight count, normalized count frequency, or term frequency—inverse document frequency. In one implementation, the bag-of-words can be implemented using N-gram tokens, such that the dictionary of tokens used in the bag-of-words analysis contains individual words as well as phrases of two or more words.

In another example, a topic modeling approach is utilized, in which latent topics in the document free text can be identified to provide data for classification. Topic modeling is an unsupervised method to detect these latent topics, which can be used as additional information for classifying events. In one example, the feature extractor 314 can generate a document-word matrix, in which each column represents a document, each row represents a term of interest, and each element represents the frequency of a given term in a given report. A truncated singular value decomposition (tSVD) analysis can be applied to the document-term matrix to generate a set of singular values representing potential topics, as well as two additional matrices relating the terms and the documents, respectively, to the potential topics. The truncation occurs in keeping only a set of the highest singular values from the set. This approach is referred to as latent semantic analysis, and the topics are referred to as latent topics. Once an appropriate set of latent topics are identified during training of the system 100, the feature extractor 314 can transform each report into a topic representation formed from the latent topics expected to generate the terms observed in the report.

In one example, the feature extractor 314 can utilize latent semantic indexing, which is a generative topic model that discovers topics in textual documents. In latent semantic indexing, a vocabulary of terms is either preselected or generated as part of the indexing process. A matrix is generated representing the frequency of occurrence of each term in the vocabulary of terms within each document, such that each row of the matrix represents a term, and each column represents a document. It will be appreciated that the frequencies can be generated as normalized count frequencies or using term frequency—inverse document frequency (tfidf). The matrix is then subjected to a dimensionality reduction technique to project the terms into a lower dimensional latent semantic space. In the illustrated example, the dimensionality reduction technique is a truncated singular value decomposition. Each document is then represented by the projected values in the appropriate column of the reduced matrix.

In another example, a word embedding approach, such as Word2Vec, or a document embedding approach, such as Doc2Vec can be used. In Word2Vec, a neural network with an input layer, in which each node represents a term, is trained on proximate word pairs within a document to provide a classifier that identifies words likely to appear in proximity to one another. The weights for the links between an input node representing a given word and the hidden layer can then be used to characterize the content of the document, including semantic and syntactic relatedness between the words.

Paragraph Vector Distributed Memory (PV-DM) is an extension of the word embedding approach. In PV-DM, context from each paragraph (or appropriate text) is included as an input to the model, and link weights associated with these inputs is generated for each paragraph as part of the training process, representing the specific context of that paragraph. Accordingly, the model is trained to predict words likely to appear in proximity to one another for a given paragraph in the document to produce a paragraph vector, with each column representing the trained context for each paragraph in the document. This can be averaged or concatenated with the word vectors for the document to generate a set of features for the document that captures embedding representations averaged across occurring words and word sequences.

In the illustrated system, the expert system 316 uses the extracted features to classify a novel document, that is, an event report that was not presented in a training set for the model, into one or more of a plurality of categories. The expert system 316 can utilize one or more pattern recognition algorithms, implemented, for example, as classification and regression models, each of which analyze the extracted features or a subset of the extracted features to classify the reports into one of the categories. The selected category can be provided to a user at an associated display (not shown) or stored on the non-transitory computer readable medium 310, for example, in a record associated with the document. One example of such an expert system can be found in U.S. Published Patent Application No. 2021/0357766, where is hereby incorporated by reference in its entirety.

The expert system 316, and any constituent pattern recognition algorithms, can be trained on a set of training data, with each sample in the set of training data comprising values for each of a set of features and an associated output class. In general, training data can be generated by applying the feature extractor 114 to documents having a known output class. An initial distribution of the values for each of the features and the output classes of the documents can be obtained and stored to represent an initial distribution of the training set. The training process of a given model will vary with its implementation, but training generally involves a statistical aggregation of training data into one or more parameters associated with the output classes. Any of a variety of techniques can be utilized for the models, including support vector machines (SVMs), regression models, self-organized maps, fuzzy logic systems, data fusion processes, boosting and bagging methods, rule-based systems, or artificial neural networks (ANNs).

A risk management component 318 monitors the properties of documents classified by the expert system 316 to ensure that the operating environment of the expert system 316 has not significantly changed. To this end, the risk management component continuously records a distribution of features from incoming samples for classification at the expert system 316 and compares the subset of features to a baseline feature distribution to determine if the current distribution of features in the incoming samples is consistent with the baseline feature distribution or represents a change in the environment from which features are drawn. Such a change in the environment can occur naturally, as the character of documents to be classified changes, but can also result from malicious action to alter the behavior of the feature extractor 314 or the datasets received at the feature extractor.

The risk management component 318 first builds up a baseline dataset sample distribution based on comparisons of incoming datasets to the baseline feature distribution representing the data used to train and test the expert system 316. It will be appreciated that the size of incoming datasets, including both the baseline dataset samples and samples to be tested, can be standardized to include at least a certain number of samples to ensure that the feature values providing a meaningful distribution. A Kullback-Leibler divergence for each dataset can then be computed to provide a set of Kullback-Leibler divergence values for the baseline dataset samples. Descriptive statistics, including a measure of central tendency and a measure of dispersion, can then be computed for this set of baseline dataset samples to represent the distribution of incoming datasets. It will be appreciated that this can be performed once, resulting in a static distribution, or windowed to allow for gradual changes in the environment to be reflected in the distribution. In one implementation, the standard deviation and mean of the set of Kullback-Leibler divergence values are used to represent the distribution.

The inventors have determined that the distribution of incoming datasets does not necessarily satisfy the presumption of normality that underlies many common techniques in statistical analysis. Accordingly, to determine a threshold Kullback-Leibler divergence value for rejecting a dataset, Chebyshev's inequality can be used. For a wide class of probability distributions, Chebyshev's inequality states that no more than 1/k² of the distribution's values can be k or more standard deviations away from the mean. Accordingly, for any desired confidence interval, a threshold number of standard deviations, and thus a threshold Kullback-Leibler divergence value, can be determined that represents a sample dataset falling outside of the confidence interval. Once this threshold is calculated from the baseline dataset samples, Kullback-Leibler divergence s for newly received datasets can be determined and compared to the threshold to determine if the newly received dataset diverges unacceptably from training dataset. Accordingly, when an incoming dataset provides a Kullback-Leibler divergence value that exceeds the determined threshold, an alarm can be provided to a user, and optionally, classification of further documents can be halted until further input from the user is received.

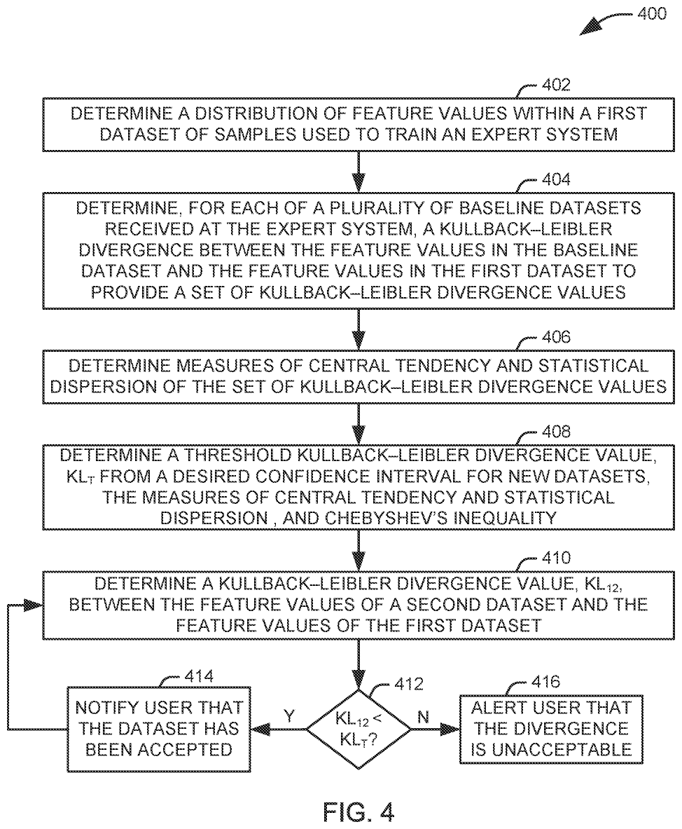

In view of the foregoing structural and functional features described above, a method in accordance with various aspects of the present invention will be better appreciated with reference to FIG. 4. While, for purposes of simplicity of explanation, the method of FIG. 4 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a method in accordance with an aspect the present invention.

FIG. 4 illustrates a method 400 for evaluating an incoming dataset for compatibility with a dataset used to train an expert system. At 402, a distribution of feature values within a first dataset of samples used to train an expert system is determined. It will be appreciated that less than all of the features used by the expert system can be used for this analysis. At 404, for each of a plurality of baseline datasets received at the expert system, a Kullback-Leibler divergence between the feature values in the baseline dataset and the feature values in the first dataset is determined to provide a set of Kullback-Leibler divergence values. It will be appreciated that the Kullback-Leibler divergence is asymmetric, and the Kullback-Leibler divergence value is representing each dataset can be the Kullback-Leibler divergence of the baseline dataset from the first dataset, the Kullback-Leibler divergence of the first dataset from the baseline dataset, or the maximum, minimum, or mean of these values.

At 406, a measure of central tendency and a measure of statistical dispersion of the set of Kullback-Leibler divergence values is determined. In one example, the mean and standard deviation of the set of Kullback-Leibler divergence values is used. At 408, a threshold Kullback-Leibler divergence value, representing an unacceptable divergence of the distribution of feature values within a new dataset from the distribution of feature values within the first dataset of samples, can be determined from a desired confidence interval for new datasets, the measure of central tendency and a measure of statistical dispersion of the set of Kullback-Leibler divergence values. In one example, the confidence interval is determined from a mean and standard deviation of the set of Kullback-Leibler divergence values and Chebyshev's inequality. For example, if a confidence interval of ninety-nine percent is desired, a threshold equal to

$$\frac{1}{\sqrt{1 - 0.99}} = 10 δ$$

can be used, where δ is the standard deviation of the set of Kullback-Leibler divergence values.

At 410, a Kullback-Leibler divergence value between the feature values of a second dataset received at the system and the feature values of the first dataset is determined. At 412, it is determined if the Kullback-Leibler divergence value between the feature values of a second dataset received at the system and the feature values of the first dataset falls below a threshold value. If so (Y), the user is notified that the second dataset has been accepted for classification at 414 and the method returns to 410 to receive another new dataset. Otherwise (N), it is determined that the second dataset represents an unacceptable divergence from the distribution of features within the first dataset of samples and a user is alerted at 416.

FIG. 5 is a schematic block diagram illustrating an exemplary system 500 of hardware components capable of implementing examples of the systems and methods disclosed herein. The system 500 can include various systems and subsystems. The system 500 can be a personal computer, a laptop computer, a workstation, a computer system, an appliance, an application-specific integrated circuit (ASIC), a server, a server BladeCenter, a server farm, etc.

The system 500 can include a system bus 502, a processing unit 504, a system memory 506, memory devices 508 and 510, a communication interface 512 (e.g., a network interface), a communication link 514, a display 516 (e.g., a video screen), and an input device 518 (e.g., a keyboard, touch screen, and/or a mouse). The system bus 502 can be in communication with the processing unit 504 and the system memory 506. The additional memory devices 508 and 510, such as a hard disk drive, server, standalone database, or other non-volatile memory, can also be in communication with the system bus 502. The system bus 502 interconnects the processing unit 504, the memory devices 506-510, the communication interface 512, the display 516, and the input device 518. In some examples, the system bus 502 also interconnects an additional port (not shown), such as a universal serial bus (USB) port.

The processing unit 504 can be a computing device and can include an application-specific integrated circuit (ASIC). The processing unit 504 executes a set of instructions to implement the operations of examples disclosed herein. The processing unit can include a processing core.

The additional memory devices 506, 508, and 510 can store data, programs, instructions, database queries in text or compiled form, and any other information that may be needed to operate a computer. The memories 506, 508 and 510 can be implemented as computer-readable media (integrated or removable), such as a memory card, disk drive, compact disk (CD), or server accessible over a network. In certain examples, the memories 506, 508 and 510 can comprise text, images, video, and/or audio, portions of which can be available in formats comprehensible to human beings.

Additionally or alternatively, the system 500 can access an external data source or query source through the communication interface 512, which can communicate with the system bus 502 and the communication link 514.

In operation, the system 500 can be used to implement one or more parts of a system for risk management in a document classification system in accordance with the present invention, in particular, the feature extractor 114, the expert system 116, and the risk management component 118. Computer executable logic for implementing the system for evaluating maintenance reports resides on one or more of the system memory 506, and the memory devices 508 and 510 in accordance with certain examples. The processing unit 504 executes one or more computer executable instructions originating from the system memory 506 and the memory devices 508 and 510. The term “computer readable medium” as used herein refers to a medium that participates in providing instructions to the processing unit 504 for execution. This medium may be distributed across multiple discrete assemblies all operatively connected to a common processor or set of related processors.

Specific details are given in the above description to provide a thorough understanding of the embodiments. However, it is understood that the embodiments can be practiced without these specific details. For example, physical components can be shown in block diagrams in order not to obscure the embodiments in unnecessary detail. In other instances, well-known circuits, processes, algorithms, structures, and techniques can be shown without unnecessary detail in order to avoid obscuring the embodiments.

Implementation of the techniques, blocks, steps, and means described above can be done in various ways. For example, these techniques, blocks, steps, and means can be implemented in hardware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed but could have additional steps not included in the figure. A process can correspond to a method, a function, a procedure, a subroutine, a subprogram, etc. When a process corresponds to a function, its termination corresponds to a return of the function to the calling function or the main function.

Furthermore, embodiments can be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks can be stored in a machine-readable medium such as a storage medium. A code segment or machine-executable instruction can represent a procedure, a function, a subprogram, a program, a routine, a subroutine, a module, a software package, a script, a class, or any combination of instructions, data structures, and/or program statements. A code segment can be coupled to another code segment or a hardware circuit by passing and/or receiving information, data, arguments, parameters, and/or memory contents. Information, arguments, parameters, data, etc. can be passed, forwarded, or transmitted via any suitable means including memory sharing, message passing, ticket passing, network transmission, etc.

For a firmware and/or software implementation, the methodologies can be implemented with modules (e.g., procedures, functions, and so on) that perform the functions described herein. Any machine-readable medium tangibly embodying instructions can be used in implementing the methodologies described herein. For example, software codes can be stored in a memory. Memory can be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” can represent one or more memories for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, wireless channels, and/or various other storage mediums capable of storing that contain or carry instruction(s) and/or data.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A method comprising:
determining a distribution of feature values within a first dataset of samples used to train an expert system;
determining, for each of a plurality of baseline datasets received at the expert system, a Kullback-Leibler divergence between the feature values in the baseline dataset and the feature values in the first dataset to provide set of Kullback-Leibler divergence values;
determining a measure of central tendency and a measure of statistical dispersion of the set of Kullback-Leibler divergence values;
determining a threshold Kullback-Leibler divergence value, representing an unacceptable divergence of the distribution of feature values within a new dataset from the distribution of feature values within the first dataset of samples, from a desired confidence interval for new datasets, the measure of central tendency of the dataset of Kullback-Leibler divergence values, and the measure of statistical dispersion of the dataset of Kullback-Leibler divergence values;
determining, for a second dataset received at the expert system, a Kullback-Leibler divergence value between the feature values of the second dataset and the feature values of the first dataset; and
determining that the second dataset represents an unacceptable divergence from the distribution of features within the first dataset of samples if the Kullback-Leibler divergence value between the feature values of the second dataset and the feature values of the first dataset exceeds the threshold value.

2. The method of claim 1, further comprising retraining the expert system with a third dataset of samples in response to determining that the second dataset represents an unacceptable divergence from the distribution of features within the first dataset of samples.

3. The method of claim 1, further comprising taking the expert system offline, such that no further samples are received, in response to determining that the second dataset represents an unacceptable divergence from the distribution of features within the first dataset of samples.

4. The method of claim 1, further comprising retraining the expert system with the first dataset of samples in response to determining that the second dataset represents an unacceptable divergence from the distribution of features within the first dataset of samples.

5. The method of claim 1, wherein the measure of central tendency of the dataset of Kullback-Leibler divergence values is a mean of the dataset of Kullback-Leibler divergence values and the measure of statistical dispersion of the dataset of Kullback-Leibler divergence values is a standard deviation of the dataset of Kullback-Leibler divergence values.

6. The method of claim 1, wherein determining the threshold Kullback-Leibler divergence value from the desired confidence interval for new datasets, the measure of central tendency of the dataset of Kullback-Leibler divergence values, and the measure of statistical dispersion of the dataset of Kullback-Leibler divergence values comprises determining a threshold Kullback-Leibler divergence value from the desired confidence interval for new datasets, the measure of central tendency of the dataset of Kullback-Leibler divergence values, the measure of statistical dispersion of the dataset of Kullback-Leibler divergence values, and Chebyshev's inequality.

7. The method of claim 1, wherein the expert system is a document classification system, and each sample of the first dataset of samples represents a document.

8. A system comprising:
a processor; and
a non-transitory computer readable medium storing computer readable instructions executable by the processor to provide:
an expert system; and
a risk management component comprising:
a training set characterization component that determines a distribution of feature values within a first dataset of samples used to train the expert system;
a baseline characterization component that determines, for each of a plurality of baseline datasets received at the expert system, a Kullback-Leibler divergence between the feature values in the baseline dataset and the feature values in the first dataset to provide a set of Kullback-Leibler divergence values, determines a measure of central tendency and a measure of statistical dispersion of the set of Kullback-Leibler divergence values, and determines a threshold Kullback-Leibler divergence value, representing an unacceptable divergence of the distribution of feature values within a new dataset from the distribution of feature values within the first dataset of samples, from a desired confidence interval for new datasets, the measure of central tendency of the dataset of Kullback-Leibler divergence values, and the measure of statistical dispersion of the dataset of Kullback-Leibler divergence values; and
a monitoring system that determines, for a second dataset received at the expert system, a Kullback-Leibler divergence value between the feature values of the second dataset and the feature values of the first dataset and determines that the second dataset represents an unacceptable divergence from the distribution of features within the first dataset of samples if the Kullback-Leibler divergence value between the feature values of the second dataset and the feature values of the first dataset exceed the threshold value.

9. The system of claim 8, the expert system comprising a document classification system and the system further comprising a feature extractor that generates each of the first dataset of samples, the second dataset, and the plurality of baseline datasets from corresponding sets of documents.

10. The system of claim 9, wherein the feature extractor generates each of the first dataset of samples, the second dataset, and the plurality of baseline datasets from corresponding sets of documents using a bag-of-words approach.

11. The system of claim 8, further comprising a retraining component that retrains the expert system in response to a determination at the monitoring system that the second dataset represents an unacceptable divergence from the distribution of features within the first dataset of samples.

12. The system of claim 11, wherein the retraining component retrains the expert system with a third dataset of samples in response to the determination the second dataset represents an unacceptable divergence from the distribution of features within the first dataset of samples.

13. The system of claim 11, wherein the retraining component restores at least a portion of the expert system from a backup in response to the determination that the second dataset represents an unacceptable divergence from the distribution of features within the first dataset of samples.

14. The system of claim 11, wherein the retraining component retrains the expert system with the first dataset of samples in response to the determination that the second dataset represents an unacceptable divergence from the distribution of features within the first dataset of samples.

15. The system of claim 8, wherein the measure of central tendency of the dataset of Kullback-Leibler divergence values is a mean of the dataset of Kullback-Leibler divergence values and the measure of statistical dispersion of the dataset of Kullback-Leibler divergence values is a standard dispersion of the dataset of Kullback-Leibler divergence values.

16. The system of claim 15, wherein determining the threshold Kullback-Leibler divergence value from the desired confidence interval for new datasets, the measure of central tendency of the dataset of Kullback-Leibler divergence values, and the measure of statistical dispersion of the dataset of Kullback-Leibler divergence values comprises determining a threshold Kullback-Leibler divergence value from the desired confidence interval for new datasets, the measure of central tendency of the dataset of Kullback-Leibler divergence values, the measure of statistical dispersion of the dataset of Kullback-Leibler divergence values, and Chebyshev's inequality.

17. A method for risk management in a document classification system, the method comprising:
determining a distribution of feature values within a first dataset of samples used to train an expert system, each of the samples in the first dataset of samples representing a document;
determining, for each of a plurality of baseline datasets received at the expert system, a Kullback-Leibler divergence between the feature values in the baseline dataset and the feature values in the first dataset to provide set of Kullback-Leibler divergence values;
determining a mean and standard deviation of the set of Kullback-Leibler divergence values;
determining a threshold Kullback-Leibler divergence value, representing an unacceptable divergence of the distribution of feature values within a new dataset from the distribution of feature values within the first dataset of samples, from a desired confidence interval for new datasets, the mean and standard deviation of the dataset of Kullback-Leibler divergence values, and Chebyshev's inequality;
determining, for a second dataset received at the expert system, a Kullback-Leibler divergence value between the feature values of the second dataset and the feature values of the first dataset; and
determining that the second dataset represents an unacceptable divergence from the distribution of features within the first dataset of samples if the Kullback-Leibler divergence value between the feature values of the second dataset and the feature values of the first dataset exceed the threshold value.

18. The method of claim 17, further comprising retraining the expert system with a third dataset of samples in response to determining that the second dataset represents an unacceptable divergence from the distribution of features within the first dataset of samples.

19. The method of claim 17, further comprising restoring at least a portion of the expert system from a backup in response to determining that the second dataset represents an unacceptable divergence from the distribution of features within the first dataset of samples.

20. The method of claim 17, further comprising retraining the expert system with the first dataset of samples in response to determining that the second dataset represents an unacceptable divergence from the distribution of features within the first dataset of samples.
